(19) United States
(12) Patent Application Publication
(10) Pub. No.: US 2012/0233274 A1
(43) Pub. Date: Sep. 13, 2012

(54) DISSEMINATION OF INFORMATION

(75) Inventors: Salvatore Salpietro, Jersey City, NJ (US); Marc De Leuw, London (GB); Elaine Margaret Davis, London (GB); Gideon Merton Joseph, London (GB)

(73) Assignee: ISEBOX Limited

(21) Appl. No.: 13/417,928

(22) Filed: Mar. 12, 2012

Related U.S. Application Data
(60) Provisional application No. 61/452,030, filed on Mar. 11, 2011.

(51) Int. Cl. G06F 15/16

(52) U.S. Cl. 709/206

(57) ABSTRACT

A system for disseminating content, comprising digital storage apparatus for storing and organizing the content, the content having portions in a plurality of formats; a processor for generating a message to alert users of the system of availability of the content; a message sender for sending the message to users of the system; a selector for a user to select which portions of the content the user wishes to receive; a delivery function for delivering portions of the content selected by the user using the selector; and apparatus for tracking and generating records of what content, or portions thereof, has been sent to each user. A method for disseminating content, using the system. A computer readable non-transitory storage medium storing instructions of a computer program, which when executed by a computer system results in performance of steps of the method for disseminating content.

This application claims priority from provisional patent application Ser. No. 61/452,030, filed on Mar. 11, 2011, which is incorporated herein by reference, in its entirety (including the appendix thereof), for all purposes.

### BACKGROUND OF THE INVENTION

1. Field of the Invention

The present disclosure relates to dissemination of information, and more specifically a system and method for dissemination of media information.

2. Description of the Related Art

The approaches described in this section are approaches that could be pursued, but not necessarily approaches that have been previously conceived or pursued. Therefore, unless otherwise indicated, the approaches described in this section may not be prior art to the claims in this application and are not admitted to be prior art by inclusion in this section.

End-users of data typically require the data to be in a particular format. For example, a video broadcaster typically requires video files formatted in accordance with a particular technical standard, for example, standard definition (SD) or high definition (HD). As such, if a content creator wishes for a broadcaster to broadcast a video, it is desirable for the content creator to provide the video to the broadcaster in an appropriate format, i.e., SD or HD.

Conventional techniques for dissemination of information from a content creator to a media outlet, e.g., a broadcaster, typically includes tasks of identifying the media outlet and providing the information, i.e., data files, to the media outlets in a particular format. These tasks can be laborious and require dedicated staff and resources to ensure that the information is successfully transmitted and received. In addition the content creator may wish to keep track of to whom the information is being disseminated, but such tracking is not readily provided by existing systems.

There exist systems for creating information, systems for formatting the information, systems for storing the information, systems for advertising the presence of the stored information, systems downloading the information, and systems for tracking the downloading of the information. However, such systems are typically independent of one another, and therefore, a person wishing to utilize such systems much also utilize a variety of tools, e.g., software products.

There is a need for a consolidated system that provides the functionality of all of the independent systems. Such a system should allow a content creator to easily prepare the information, and allow a media outlet to easily obtain the information in an appropriate format.

### SUMMARY OF THE INVENTION

In general, an embodiment of the invention is directed to system for disseminating content, comprising digital storage apparatus for storing and organizing the content, the content having portions in a plurality of formats; a processor for generating a message to alert users of the system of availability of the content; a message sender for sending the message to users of the system; a selector for a user to select which portions of the content the user wishes to receive; a delivery function for delivering portions of the content selected by the user, using the selector; and apparatus for tracking and generating records of what content, or portions thereof, has been sent to each user.

The processor can produce a message in the form of a digital press release, and can assigns a URL to the digital press release. The digital press release can be sent by one of email having a link to the press release, a link to a web page having access to the press release and the press release being included in the email. The digital press release can contain a plurality of fields selected from the group consisting of a headline, a quote title, a quote, a quote author, an address, a website, content, and a logo.

Users of the system can be at least one of advertisers and media outlets. Content can be supplied by an entity wishing to conduct at least one advertising campaign. The content can be organized in memory with respect to the at least one campaign. Each campaign can has, associated with it, a plurality of digital press releases.

The content can include at least a plurality of computer files stored in the digital storage apparatus, for items selected from the group consisting of text, image, audio, standard definition video, high definition video, brand information, contact information, publishing information and Add Docs.

The system can further comprise a report generator for generating a usage report in response to the records. Data for usage reports can be obtained by software which parses user identification data obtained for a variety of log-in sources, and converts the data to a format for storage in a CVS file format.

All of the elements of the system can be consolidated into a single system for performing all functions. The system can be used in combination with a plurality of devices for accessing the system, the devices being connected to the system via the Internet. The system can be configured to allow users to receive the messages and to access the content with the devices. The system can be configured to allow content providers to produce the content and upload the content to the system by using one of the devices. The system can provide a template to be supplied to a content creator, so that portions of the content are placed in the template. At least a portion of the users can have a password for the system, and the password can permit a user to access portions of the content that are not accessible without having a password. Provisions may be made for editing or deleting the content, or portions of the content.

The selector can comprise a carousel for selecting content to be supplied to a user.

An embodiment of the invention is directed to a method for disseminating content, comprising storing and organizing the content, the content having portions in a plurality of formats, in a digital storage apparatus; generating a message to alert users of the system of availability of the content; sending the message to users of the system; the user selecting which portions of the content the user wishes to receive; delivering portions of the content selected by the user; and tracking and generating records of what content, or portions thereof, has been sent to each user.

Yet another embodiment of the invention is directed to a computer readable non-transitory storage medium storing instructions of a computer program which when executed by a computer system results in performance of steps of a method for disseminating content, comprising storing and organizing the content, the content having portions in a plurality of formats, in a digital storage apparatus of the computer system; a processor of the computer system generating a message to alert users of the system of availability of the content; the computer system sending the message to users of the system; the user selecting which portions of the content the user wishes to receive; the computer system delivering portions of the content selected by the user; and the computer system tracking and generating records of what content, or portions thereof, has been sent to each user.

### BRIEF DESCRIPTION OF THE DRAWINGS

FIG. 1 is a block diagram of system that disseminates and tracks information.

FIG. 1A is a block diagram of a database showing that the database is being used to store information for a plurality of media campaigns.

FIGS. 2-5 are illustrations of a user interface that is presented on a device to facilitate an uploading of content to a database.

FIG. 6 is an illustration of a user interface that is presented on a device to facilitate an end-user's review and downloading of a media release from a database to a device.

FIG. 7 is an illustration of a dialogue box that is presented by a user interface.

FIG. 8 is a block diagram that shows that a media release is being distributed in a particular version, and to various devices.

FIG. 9 is a flow chart of a method for disseminating and tracking of information.

A component or a feature that is common to more than one drawing is indicated with the same reference number in each of the drawings.

### DESCRIPTION OF THE INVENTION

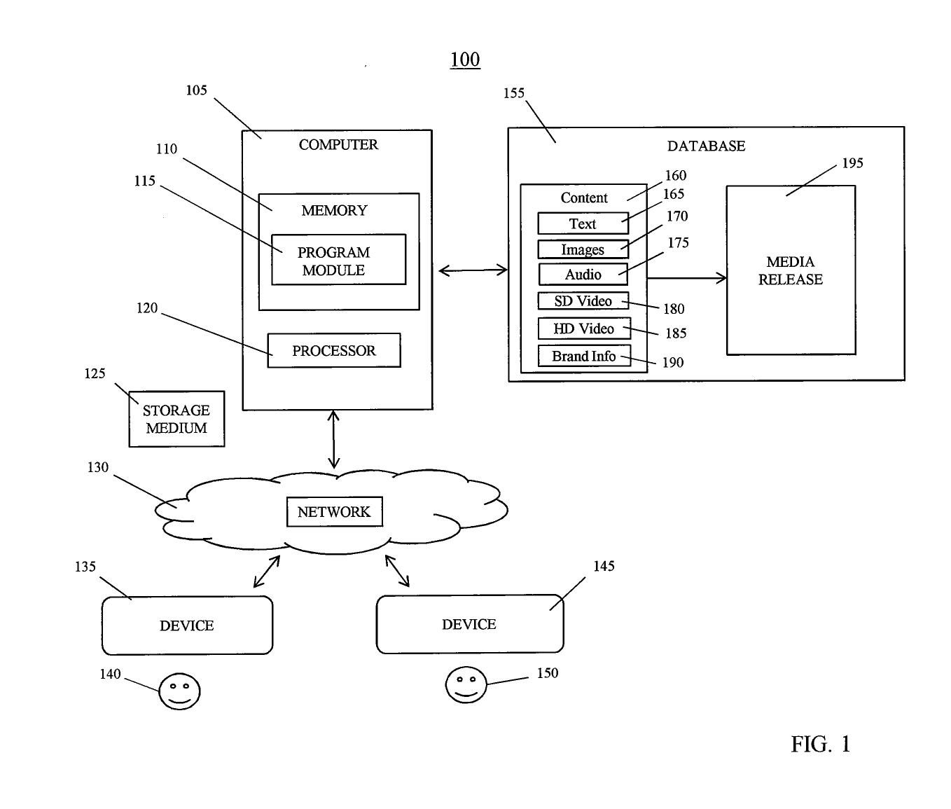

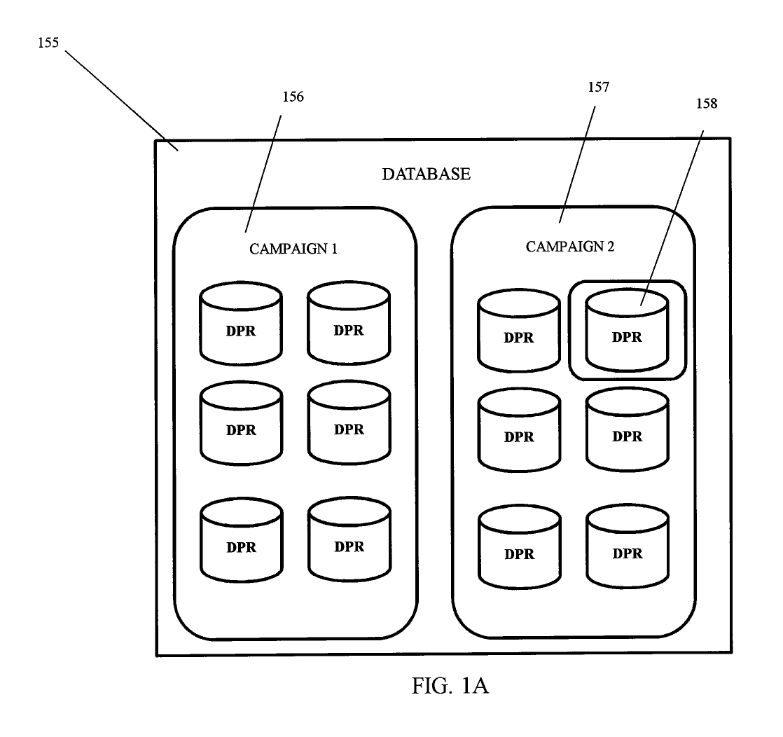

FIG. 1 is a block diagram of system 100 that disseminates and tracks information. System 100 includes a device 135, a device 145, a network 130, e.g., the Internet, a computer 105, and a database 155. Device 135 is utilized by a content creator 140. Device 145 is utilized by an end-user 150, e.g., a media outlet.

Computer 105 includes a processor 120 and a memory 110. Although computer 105 is represented herein as a standalone device, it is not limited to such, but instead can be coupled to other devices (not shown) in a distributed processing system.

Processor 120 is an electronic device configured of logic circuitry that responds to and executes instructions.

Memory 110 is a non-transitory computer-readable storage medium encoded with a computer program. In this regard, memory 110 stores data and instructions that are readable and executable by processor 120 for controlling the operation of processor 120. Memory 110 may be implemented in a random access memory (RAM), a hard drive, a read only memory (ROM), or a combination thereof. One of the components of memory 110 is a program module 115.

Program module 115 contains instructions for controlling processor 120 to execute methods described herein. The term “module” is used herein to denote a functional operation that may be embodied either as a stand-alone component or as an integrated configuration of a plurality of sub-ordinate components. Thus, program module 115 may be implemented as a single module or as a plurality of modules that operate in cooperation with one another. Moreover, although program module 115 is described herein as being installed in memory 110, and therefore being implemented in software, it could be implemented in any of hardware (e.g., electronic circuitry), firmware, software, or a combination thereof.

While program module 115 is indicated as being already loaded into memory 110, it may be configured on a storage medium 125 for subsequent loading into memory 110. Storage medium 125 is also a non-transitory computer-readable storage medium and can be any conventional storage medium that stores program module 115 thereon. Examples of storage medium 125 include a floppy disk, a compact disk, a magnetic tape, a read only memory, an optical storage media, universal serial bus (USB) flash drive, a digital versatile disc, or a zip drive. Alternatively, storage medium 125 can be a random access memory, or other type of electronic storage, located on a remote storage system and coupled to computer 105 via network 130.

Device 135 and device 145 are devices that are capable of communicating with computer 105 via network 130. Each of device 135 and device 145 may be implemented, for example, as a computer.

Content creator 140 uploads content 160 from device 135 to database 155, via network 130 and computer 105. Content 160 includes any or all of content items of text 165, images 170, audio 175, SD video 180, HD video 185, and brand info 190. Text 165 is in a text format or a word processor format. Images 170 are in an image format. Audio 175 is in an audio format. SD video 180 is video in SD format. HD video 185 is video in HD format. Brand info 190 is brand information, such as a logo, and can be in any appropriate data format, e.g., a logo in an image format.

From content 160, processor 120 generates a media release 195 in accordance with instructions in program module 115. Media release 195 is also designated herein as a digital press release (DPR). Media release 195 is assigned a uniform resource locater (URL), and through use of the URL, is accessible by devices coupled to network 130.

End-user 150 receives a communication that notifies end-user 150 of the existence of media release 195. For example, content creator 140 can provide the notification by way of an email to end-user 150, where the email includes a link to media release 195, or a link to a webpage that in turn provides access to media release 195. As an alternative, processor 120 can transmit the email to end-user 150.

It is noted that other types of messages besides email, such as instant messages, tweets, etc. may sent by the system. As an alternative, to the system sending out the messages directly, a service may be used which has adequate resources and bandwidth to reach millions of end users.

End-user 150 using device 145, accesses media release 195, and if desired, downloads to device 145, some or all of content 160.

A company may release a product or service, and organizes information relating to a product or a service according to a campaign.

FIG. 1A is a block diagram of database 155 showing that database 155 is being used to store information for a plurality of media campaigns. Database 145 includes a plurality of digital press releases organized in a campaign 156 and a campaign 157. Each of campaign 156 and campaign 157 is for a different media strategy. For example, campaign 156 may contain DPRs for a particular service or a particular product, and campaign 157 may contain DPRs for publicizing changes of management. Media release 195, which as mentioned above is also referred to as a DPR, is a part of campaign 157.

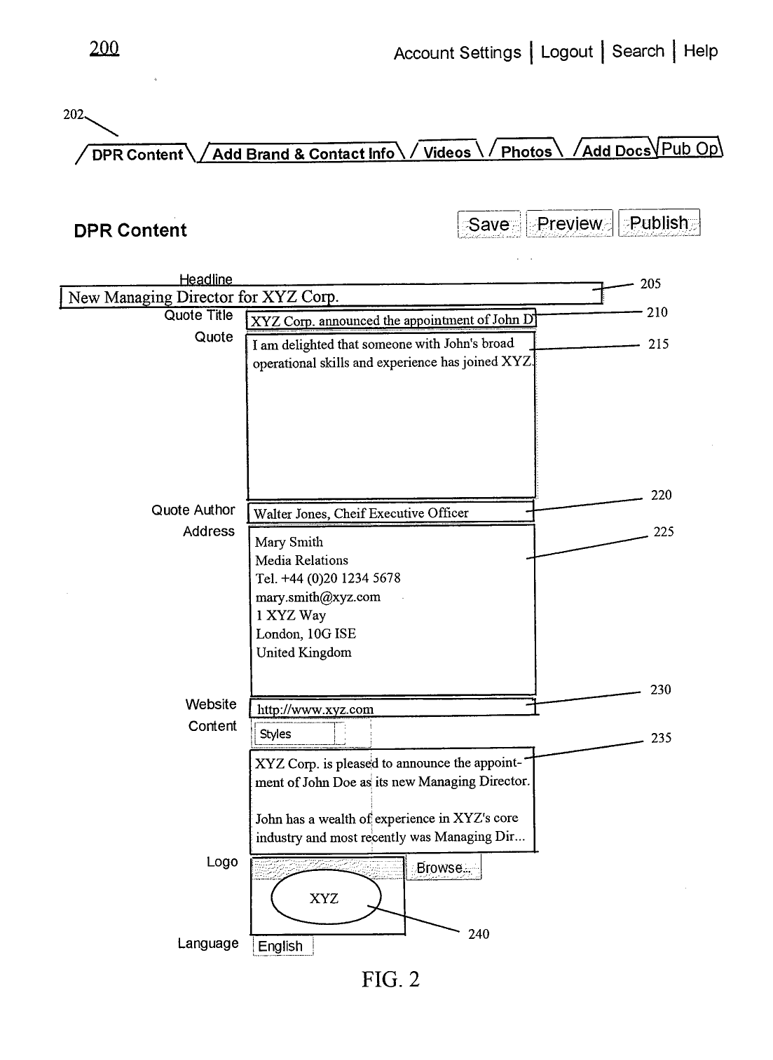

FIGS. 2-5 are illustrations of a user interface 200 that is presented on device 135 to facilitate the uploading of content 160 to database 155. User interface 200 is generated by processor 120 in accordance with instructions in program module 115.

User interface 200 includes tabs 202 that are selectable by content creator 140 to provide DPR Content, Add Brand & Contact Info, Videos, Photos, Add Docs, and Publishing Options (Pub Op). After selecting DPR content, content creator 140 can enter text into a template, and upload it to database 155, and thereafter edit or delete the text. After selecting Add Brand & Contact Info, content creator 140 can upload add brand information and contact information to database 155, and thereafter edit or delete the brand information and contact information. After selecting Videos, content creator 140 can upload a video to database 155, and thereafter edit or delete the video. After selecting Photos, content creator 140 can upload images to database 155, and thereafter edit or delete the images. After selecting Add Docs, content creator 140 can upload a document to database 155, and thereafter edit or delete the document. After selecting Pub Op, content creator 140 can specify publishing options, and thereafter edit or delete the publishing options.

In FIG. 2, the tab for DPR Content is selected, and content creator 140 has provided information in fields for each of a headline 205, a quote title 210, a quote 215, a quote author 220, an address 225, a website 230, content 235, and a logo 240. Headline 205, quote title 210, quote 215, quote author 220, address 225, website 230, and content 235 are stored in text 165. Logo 240 is stored in brand info 190.

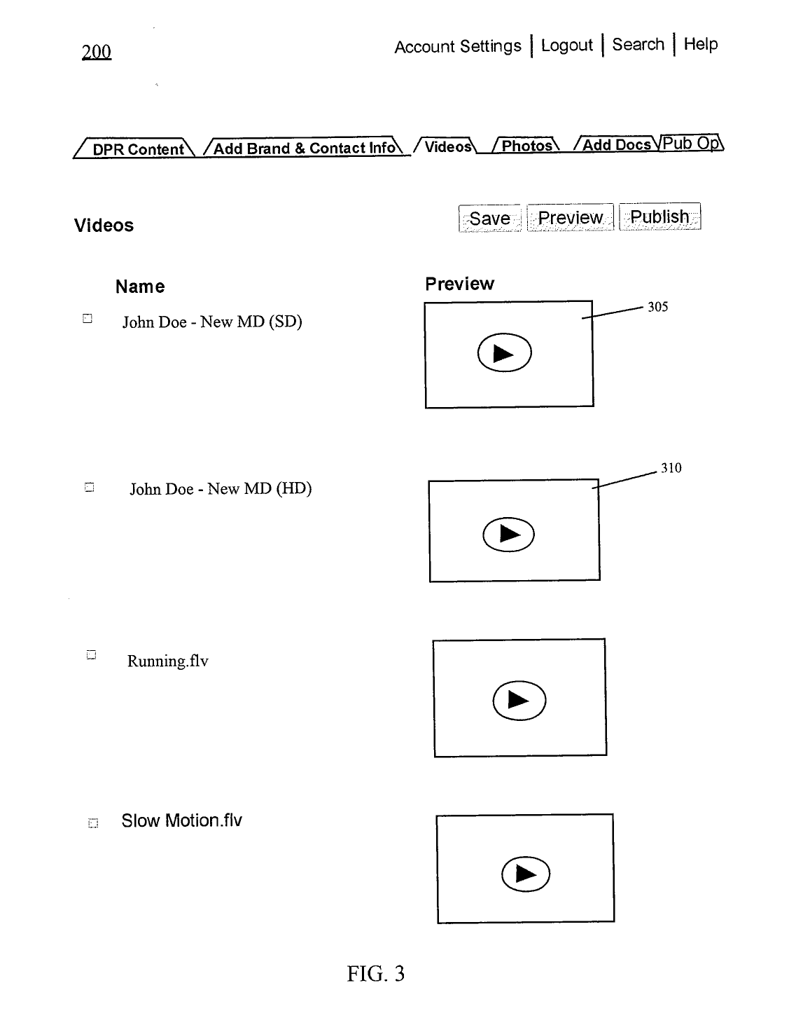

In FIG. 3, the tab for Videos is selected, and content creator 140 has uploaded several videos, one of which is named “John Doe—New MD (SD)”, and designated as video 305, and one of which is named “John Doe—New MD (HD)”, and designated as video 310. Video 305 is in SD format and stored in SD video 180, and video 310 is in HD format and stored in HD video 185. Ordinarily, if content creator 140 wishes for a video to be available in media release 195 in both SD format and HD format, content creator 140 must upload a video in SD format, e.g., video 305, and a video in HD format, e.g., video 310. However, computer 105 could also include a reformatting application (not shown) that content creator 140 could invoke through user interface 200 to reformat a video that content creator 140 provides in a first format, to a second format.

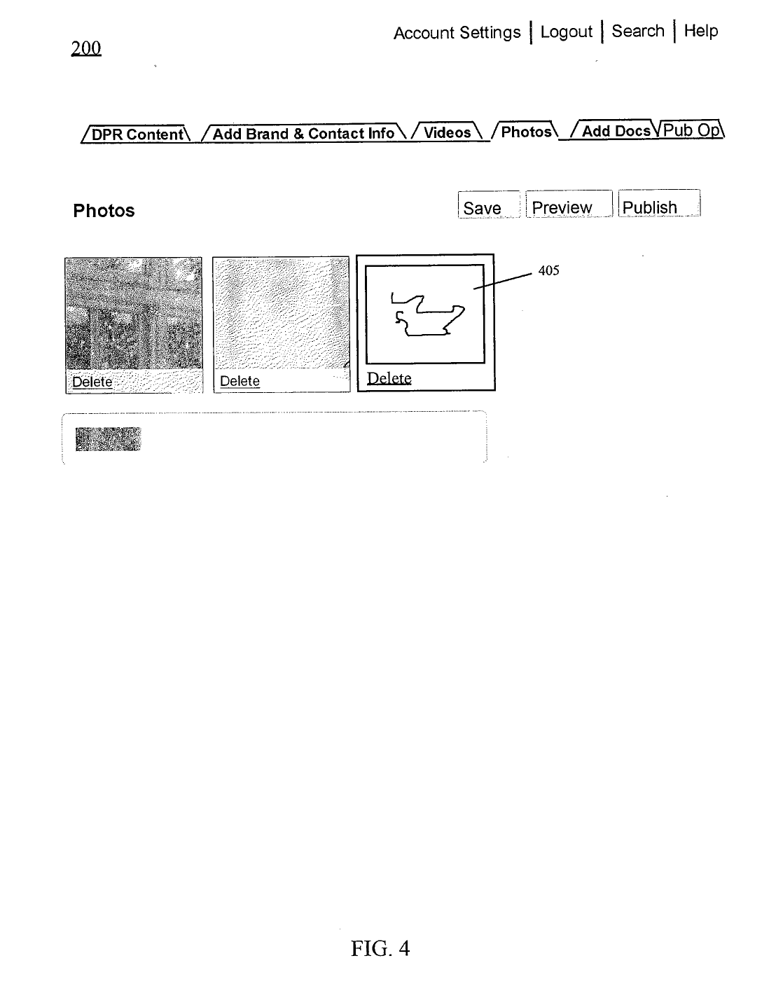

In FIG. 4, the tab for Photos is selected, and content creator 140 has uploaded several photos, i.e., images, one of which is designated as image 405. Image 405 is stored in images 170.

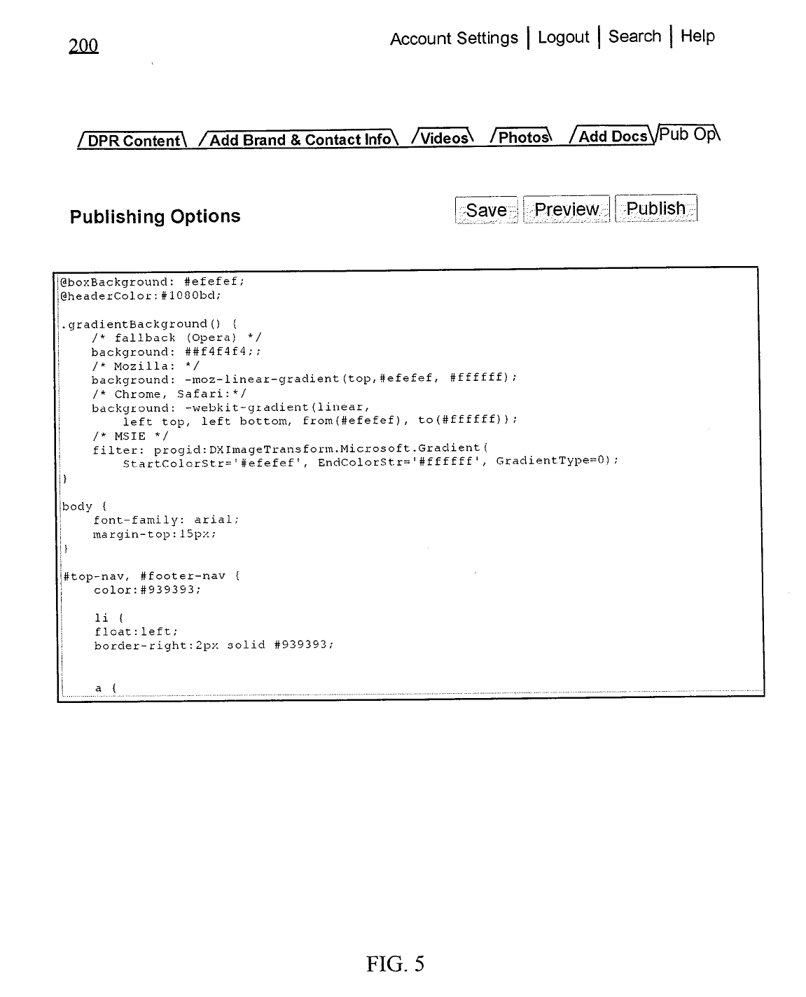

In FIG. 5, the tab for Publishing Options is selected, and content creator 140 has specified publishing options.

Although not shown in FIGS. 2-5, user interface 200 also facilitates an uploading of audio information that is stored in audio 175.

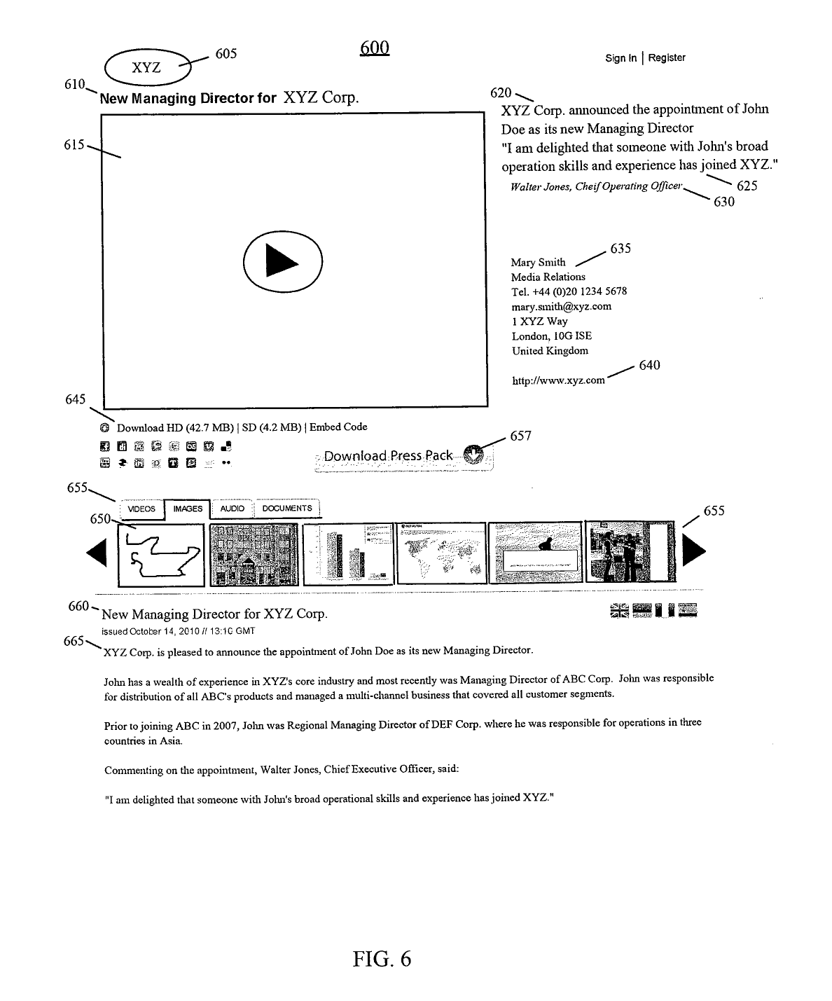

FIG. 6 is an illustration of a user interface 600 that is presented on device 145 to facilitate end-user 150's review and downloading of media release 195 from database 155 to device 145. Thus, user interface 600 is effectively a visual representation of media release 195. User interface 600 is generated by processor 120 in accordance with instructions in program module 115.

User interface 600 includes fields for a logo 605, a headline 610, a video 615, a quote title 620, a quote 625, a quote author 630, an address 635, a website 640, and image 650, a headline 660, and content 665. Logo 605 is derived from logo 240. Headline 610 is derived from headline 205. Video 615 is derived from video 305 or video 310. Quote title 620 is derived from quote title 210. Quote 625 is derived from quote 215. Quote author 630 is derived from quote author 220. Address 635 is derived from address 225. Website 640 is derived from website 230. Image 650 is derived from image 405. Headline 660 is derived from headline 205. Content 665 is derived from content 235.

End-user 150 can play video 615. However, on user interface 600, video 615 is not necessarily presented in either of SD or HD format, but instead, a relatively low-quality, or low resolution, format. If end-user 150 wishes to download video 615, end-user 150 would then utilize a download control 645 and select the desired format. For example, if end-user 150 wished to download video 615 in SD format, end-user 150 would select “SD (4.2 MB)” from within download control 645, and accordingly, processor 120 will (a) obtain video 305 from database 155, and (b) transmit video 305 to device 145. Similarly, if end-user 150 wished to download video 615 in HD format, end-user 150 would select “HD (42.7 MB)” from within download control 645, and accordingly, processor 120 will (a) obtain video 310 from database 155, and (b) transmit video 310 to device 145.

Tabs 655 provide for a selection of videos, images, audio, and documents to be presented on a carousel 655. In FIG. 6, the tab for images is selected, and accordingly, a plurality of images that are presented on carousel 655. Image 650 is one of the plurality of images. Carousel 655 includes controls for left rotation and right rotation of the plurality of images. If one of the other tabs (video, audio or documents) is selected, then carousel 655 presents thumbnail images that represent available videos, audio or documents.

If a broadcaster desires a press pack, then the broadcaster may select a Download Press Pack control 657.

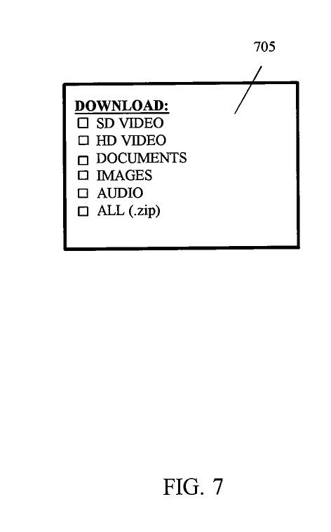

FIG. 7 is an illustration of a dialogue box 705 that is presented by user interface 600 in a case where end-user 150 selects Download Press Pack control 650. Dialogue box 705 includes boxes that end-user 150 can check to identify one or more items of content 160 that end-user 150 wishes to download. For example, if end-user 150 is a television broadcaster, then end-user 150 may desire SD video or HD video. If end-user-150 is a newspaper or magazine publisher, then end-user 150 may desire documents or images. If end-user 150 is a radio broadcaster, then end-user 150 may desire audio. Processor 120 will obtain from database 155, and transmit to device 145, the items that are selected in dialogue box 705. One of the boxes is identified as “ALL (.zip)”, which, when selected, causes processor 120 to provide all of the content items, effectively all of media release 195.

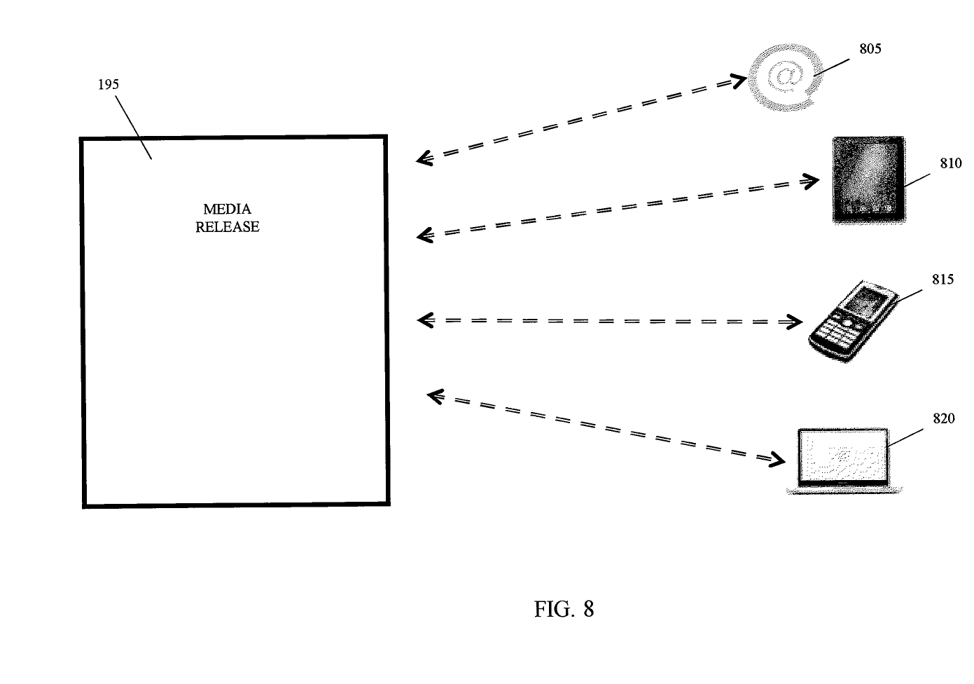

FIG. 8 is a block diagram that shows that media release 195 being distributed in a LITE version 805, and to various devices 810, 815 and 820.

LITE version 805 is a relatively static version of media release 195 that is similar in appearance to user interface 600, but does not include all of the functionality of user interface 600. For example, LITE version 600 may include an image similar to that of carousel 655, but does not itself provide for the rotation of images. However, the entire image presented in LITE version 805, or a substantial portion of that image, is itself a hyperlink to the URL through which media release 195 is accessed. Therefore, when end-user 150 clicks on LITE version 805, device 145 is placed in communication with processor 120, and in turn, presented with a proper version of user interface 600. LITE version 805 can be sent in an email to device 145, and may be, for example, in the email described above that notifies end-user 150 of the existence of media release 195.

Device 810 is a tablet-type device for viewing a MOBILE version of media release 195. Processor 120 interacts with device 810 via a version of user interface 600 that is suitable for device 810.

Device 815 is a mobile device, e.g., a cell phone, which views either a FEED or MOBILE version of media release 195. Processor 120 interacts with device 815 via a version of user interface 600 that is suitable for device 815.

Access device 820 is a computing device, e.g., a laptop, which views a FULL version or the FEED version of media release 195. Processor 120 interacts with device 820 via a version of user interface 600 that is suitable for device 820.

In view of the increasing functionality present on most portable devices, content may be created on any of devices 810, 815 or 820 for uploading to the database 155 for use in a campaign. While an application for this purpose may be provided on devices 810, 815 or 820, generally no special application will be required.

Processor 120, prior to downloading information to device 145, requires that end-user 150 have an account that provides information about end-user 150, such as a name, an email address, an organization, an employer, a country, a city, a website, a telephone number, a date of information request, a content request, a gender, and an age. The account may be an account that is managed by processor 120, and accordingly, processor 120 provides for the creation and storage of account information. Alternatively, the account may be a preexisting account with a third-party service such as an Internet portal or a social networking site. In the case of the login information being provided from a third-party service, end-user 150 would typically be logged into the third-party service, and while using the third-party service, click on a link that initiates communication between device 145 and processor 120.

In addition, when providing a download of information, processor 120 prepares a transaction report. The transaction report indicates that end-user 150 has requested particular items of content from media release 195, and also includes information about end-user 150, such as a name, an email address, an organization, an employer, a country, a city, a website, a telephone number, a date of information request, a content request, a gender, and an age. This information about end-user 150 is part of the account information that is provided by end-user 150, or obtained from the third-party service. The transaction report thus provides information that content creator 140 can utilize to track and monitor the dissemination of the information requested by end-user 150.

Transaction reports can be further processed to reveal information about end-users as a group. For example, such information may include a frequency of requests for information and demographic information of end-users that have requested downloads of media release 195.

Data for user or transaction reports may be obtained regardless of the manner in which a user logs onto the system. For example, logging on may be accomplished by way of a user name, an account name, or any other terminology that is used for a variety of sources such as Facebook, Twitter, LinkedIn, etc. All of this information is parsed, converted as may be appropriate, and stored in a CVS file format, which may be exported to be used with, for example, Excel or other spread sheet programs to allow the data to be viewed and processes as desired.

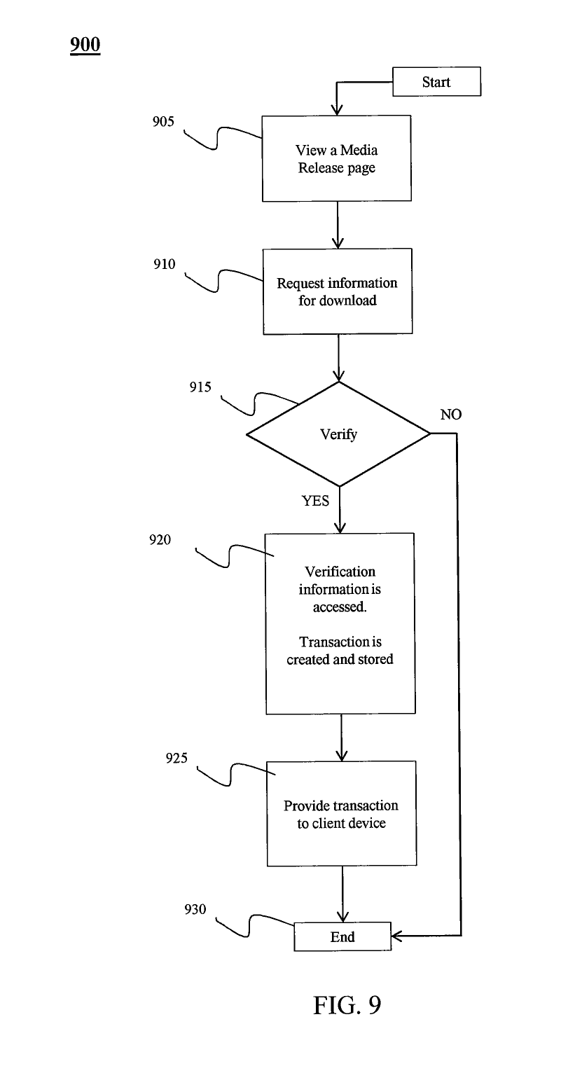

FIG. 9 is a flow chart of a method 900 for disseminating and tracking of information. Method 900 is performed by processor 120 in accordance with instructions in program module 115. Method 900 commences with step 905.

In step 905, receives a communication from device 145 indicating that device 145 is seeking to access media release 195. The communication may result, for example, from end-user 150 clicking on a link in an email or on a website. Accordingly, processor 120 presents, to device 145, user interface 600, which is effectively a representation of media release 195. End-user 150 interacts with processor 120 via user interface 600. From step 905, method 900 advances to step 910.

In step 910, end-user 150, via user interface 600, selects content for downloading. Accordingly, processor 120 receives, from device 145, a communication that indicates end-user 150's selection. From step 910, method 900 progresses to step 915.

In step 915, processor 120 verifies that end-user 145 is entitled to receive selected content. The verification requires that end-user 145 provides login information. As mentioned above, the login information may be directly provided by end-user 145, or by way of a communication from a third-party service such as an Internet portal or a social networking website with which end-user 150 is registered.

Step 915 may require additional information such as an organization name or a company name. If the verification is successful, method 900 progresses to step 920. If the verification is not successful, method 900 advances to step 930.

In step 920, processor 120 obtains the desired content from database 155. Processor 120 also generates a transaction report. From step 920, method 900 progresses to step 925.

In step 925, processor 120 sends the content to device 145. From step 925, method 900 progresses to step 930.

In step 930, method 900 ends.

It will be understood that the invention may be embodied in a computer readable non-transitory storage medium storing instructions of a computer program which when executed by a computer system results in performance of steps of the method described herein. Such storage media may include any of those mentioned in the description above.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof.

What is claimed is:

1. A system for disseminating content, comprising:
digital storage apparatus for storing and organizing the content, the content having portions in a plurality of formats;
a processor for generating a message to alert users of the system of availability of the content;
a message sender for sending the message to users of the system;
a selector for a user to select which portions of the content the user wishes to receive;
a delivery function for delivering portions of the content selected by the user, using the selector; and
apparatus for tracking and generating records of what content, or portions thereof, has been sent to each user.

2. The system of claim 1, wherein the processor produces a message in the form of a digital press release.

3. The system of claim 2, wherein the processor assigns a URL to said digital press release.

4. The system of claim 2, wherein the digital press release is sent by one of email having a link to the press release, a link to a web page having access to the press release and the press release being included in the email.

5. The system of claim 2, wherein the digital press release contains a plurality of fields selected from the group consisting of a headline, a quote title, a quote, a quote author, an address, a website, content, and a logo.

6. The system of claim 1, wherein the users are at least one of advertisers and media outlets.

7. The system of claim 1, wherein the content is supplied by an entity wishing to conduct at least one advertising campaign, and the content is organized in memory with respect to said at least one campaign.

8. The system of claim 7, wherein said at least one campaign has, associated with each campaign, a plurality of digital press releases.

9. The system of claim 1, wherein the content includes at least a plurality of computer files stored in said digital storage apparatus, for items selected from the group consisting of text, image, audio, standard definition video, high definition video, brand information, contact information, publishing information and Add Docs.

10. The system of claim 1, further comprising a report generator for generating a usage report in response to said records.

11. The system of claim 1, wherein data for usage reports is obtained by software which parses user identification data obtained for a variety of log in sources, and converts the data to a format for storage in a CVS file format.

12. The system of claim 1, wherein the elements thereof are consolidated into a single system for performing all functions.

13. The system of claim 1, in combination with a plurality of devices for accessing the system, said devices being connected to said system via the Internet.

14. The system of claim 13, configured to allow users to receive said messages and to access said content with said devices.

15. The system of claim 13, configured to allow content providers to produce said content and upload said content to said system by using one of said devices.

16. The system of claim 1, wherein at least a portion of said users have a password for said system, and said password permits a user to access portions of said content that are not accessible without having a password.

17. The system of claim 1, further comprising a template supplied to a content creator, so that portions of said content are placed in said template.

18. The system of claim 1, further comprising provisions for editing or deleting said content, or portions of said content.

19. The system of claim 1, wherein said selector comprises a carousel for selecting content to be supplied to a user.

20. A method for disseminating content, comprising:
storing and organizing the content, the content having portions in a plurality of formats, in a digital storage apparatus;
generating a message to alert users of the system of availability of the content;
sending the message to users of the system;
the user selecting which portions of the content the user wishes to receive;
delivering portions of the content selected by the user; and
tracking and generating records of what content, or portions thereof, has been sent to each user.

21. A computer readable non-transitory storage medium storing instructions of a computer program which when executed by a computer system results in performance of steps of a method for disseminating content, comprising:
storing and organizing the content, the content having portions in a plurality of formats, in a digital storage apparatus of said computer system;
a processor of said computer system generating a message to alert users of the system of availability of the content;
the computer system sending the message to users of the system;
the user selecting which portions of the content the user wishes to receive;
the computer system delivering portions of the content selected by the user; and
the computer system tracking and generating records of what content, or portions thereof, has been sent to each user.
